(19) United States
(12) Patent Application Publication
(10) Pub. No.: US 2002/0104747 A1
(43) Pub. Date: Aug. 8, 2002

(54) Motor operator for electric power switch and electric power switches incorporating the same

(76) Inventors: David Curtis Turner, Imperial, PA (US); David Michael Olszewski, Mckees Rocks, PA (US); Craig Joseph Puhalla, Moon Township, PA (US)

Correspondence Address: Martin J. Morgan,, Cutler-Hammer Products,, Technology and Quality Center, 170 Industry Drive - RIDC Park West, Pittsburgh, PA, 15275, US

(21) Appl. No.: 09/777,541

(22) Filed: Feb. 6, 2001

(51) Int. Cl. H01H 3/20

(52) U.S. Cl. 200/330

(57) ABSTRACT

A motor operator for an electric power switch having a handle moveable along a rectilinear path includes a threaded shaft mounted for rotation parallel to movement of the handle. A molded flexible coupling has a drive section with a threaded through bore engaging the threaded shaft and a yoke section having a hole engaged by the handle. The yoke section is joined to the drive section by an integral flexible intermediate section formed by a pair of slits extending generally parallel to the through bore. As the threaded shaft is rotated by a motor, the drive coupling, and with it the handle, are driven between OFF and ON positions. During startup of the motor, toggling of the handle by a toggle mechanism in the switch, and deceleration at the end of travel, when the drive section of the drive coupling and the yoke section travel at different speeds, one or the other of the slits closes as the intermediate section bends to dampen the effect.

### BACKGROUND OF THE INVENTION

1. Field of the Invention

This invention relates to electric power switches and to motor driven apparatus for operating the handles of such switches.

2. Background Information

Electric power switches, such as circuit breakers, disconnect switches and transfer switches, for instance, typically have a handle by which the contacts of the switch can be manually opened and closed. In addition, circuit breakers include a trip unit which automatically opens the switch in response to currents which exceed defined amplitude/time characteristics. Often, these electric power switches have a spring powered toggle mechanism which snaps the switch to the open or closed position once the handle moves beyond a toggle point.

In many applications, a motor operator is provided to position the circuit breaker handle. The motor operator makes is easier to operate large electric power switches and also provides the capability of remote operation. A common type of motor operator has a carriage which engages the handle of the circuit breaker. The carriage is reciprocally driven to move the handle to the ON and OFF positions by a threaded shaft which is rotated by an electric motor. In order to reduce the starting torque required for the motor to overcome the spring force of the switch toggle mechanism, it is known to incorporate a spring into the carriage, which allows a motor of lower torque to gain some momentum before initiating movement of the switch handle. Thus, the switch handle lags the motor operator carriage initially. However, when the switch handle passes the toggle point, the handle tends to move faster than the carriage momentarily. Microswitches terminate motor energization at the ends of carriage travel. However, momentum can cause the carriage to strike the support at the end of the threaded shaft and rebound, possibly to the point where the microswitch is deactuated and the motor is reenergized. This can result in “pumping”as the motor repetitively turns on and off and drives the carriage into the support. One remedy for this problem has been to extend a helical compression spring from the carriage perpendicular to the path of the carriage at the midpoint of travel, so that the carriage is biased toward either end of travel thereby dampening the tendency to rebound.

It can be appreciated, therefore, that there is room for improvement in such motor operators and electric power switches equipped with them.

### SUMMARY OF THE INVENTION

This invention is directed to an improved motor operator for electric power switches having a handle reciprocally moveable along a rectilinear path. The motor operator comprises a threaded shaft mounted adjacent and substantially parallel to the rectilinear path of the handle, a motor rotating the threaded shaft, and a flexible molded drive coupling having a drive section with a threaded through bore extending from a first end to a second end and engaging the threaded shaft. The molded drive coupling also includes a yoke section lateral of the drive section and having a hole extending generally transverse to the through bore for engaging the handle. An integral intermediate section of the drive couple joining the drive section and the yoke section is formed by first and second slits extending generally parallel to the through bore from the first and second ends of the drive coupling. A guide prevents rotation of the drive coupling with rotation of the threaded shaft so that the drive coupling travels along the threaded shaft and moves the handle along the rectilinear path as the motor rotates the threaded shaft. The intermediate section is flexible and bends to selectively close the first and second slits in response to differences in travel speeds of the drive section and the yoke section. Thus, the flexible molded drive coupling allows the motor to accelerate the drive coupling on startup before the handle is moved, thereby permitting the use of a motor with lower torque. It also dampens the effect of the handle toggling between the ON and OFF positions and absorbs the impact of the coupling striking the end of travel to prevent “pumping” of the drive motor.

The invention also embraces an electric power switch incorporating the improved motor operator.

### BRIEF DESCRIPTION OF THE DRAWINGS

A full understanding of the invention can be gained from the following description of the preferred embodiments when read in conjunction with the accompanying drawings in which:

FIG. 1 is an isometric view of a circuit breaker with a motor operator incorporating the invention;

FIG. 2 is a side elevation view of the circuit breaker and motor operator;

FIG. 3 is a plan view with the cover removed of the motor operator incorporating the invention shown with the handle in the TRIPPED position and the end portion removed for clarity;

FIG. 4 is an isometric view of a coupling which forms part of the invention;

FIG. 5 is a plan view showing reaction of the coupling of FIG. 4 to certain conditions; and

FIG. 6 is a plan view of the coupling showing reaction of the coupling to other conditions.

### DESCRIPTION OF THE PREFERRED EMBODIMENTS

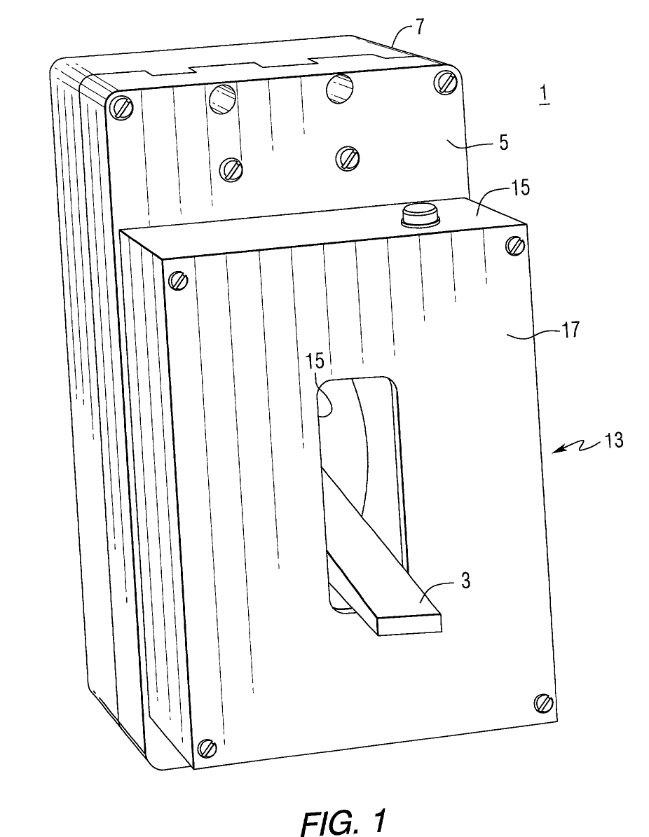

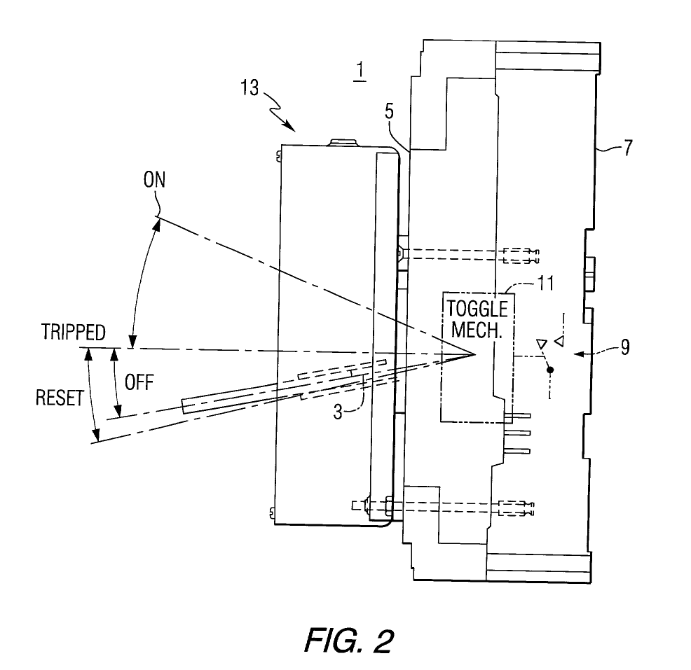

FIGS. 1 and 2 illustrate an electric power switch, which for purposes of illustration, is a circuit breaker 1 such as a well known low voltage molded case circuit breaker. It will be appreciated by those skilled in the art that the invention has application to other electric power switches such as disconnect switches and transfer switches, for example.

The circuit breaker 1 has a handle 3 projecting from a front face 5 of a switch housing or molded casing 7. The handle 3 moves along an essentially rectilinear path between ON and OFF positions, with an intermediate tripped position and a reset position beyond the OFF position, as is well known. As the handle is moved between the ON and OFF positions, it opens and closes separable contacts 9 connected in the distribution circuit to be protected (not shown). The handle 3 is connected to the separable contacts 9 through a toggle mechanism 11. Such well known toggle mechanisms incorporate springs which cause the separable contacts, and the handle 3, to move rapidly once the handle is moved beyond the toggle position going toward the OFF or ON positions. In the case of a circuit breaker, a trip unit (not shown) is also provided, which automatically actuates the toggle mechanism to open the separable contacts in response to selected amplitude/time characteristics of current in the protected circuit. When the separable contacts are tripped open, the handle is moved to an intermediate tripped position.

While the handle 3 of the circuit breaker 1 can be operated manually, a motor operator 13 is often used to provide the substantial force needed to operate a larger circuit breaker and/or to offer the capability of remote operation. The motor operator 13 is bolted to the front face 5 of the circuit breaker 1 over the handle 3. The handle 3 is extended so that it protrudes through the front face of the motor operator to maintain the capability for alternative manual operation. The motor operator 13 includes an enclosure 15 with a removable lid 17.

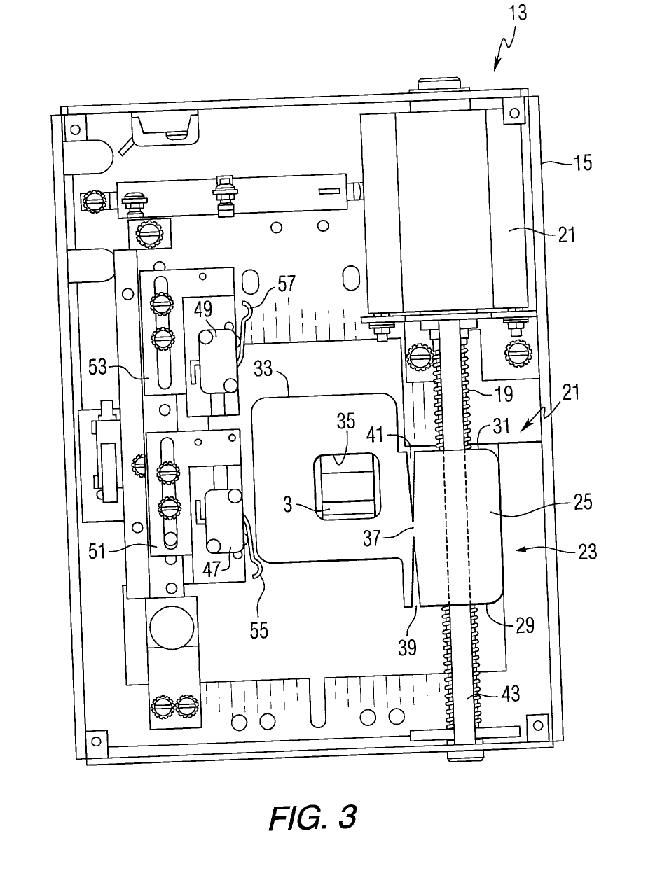

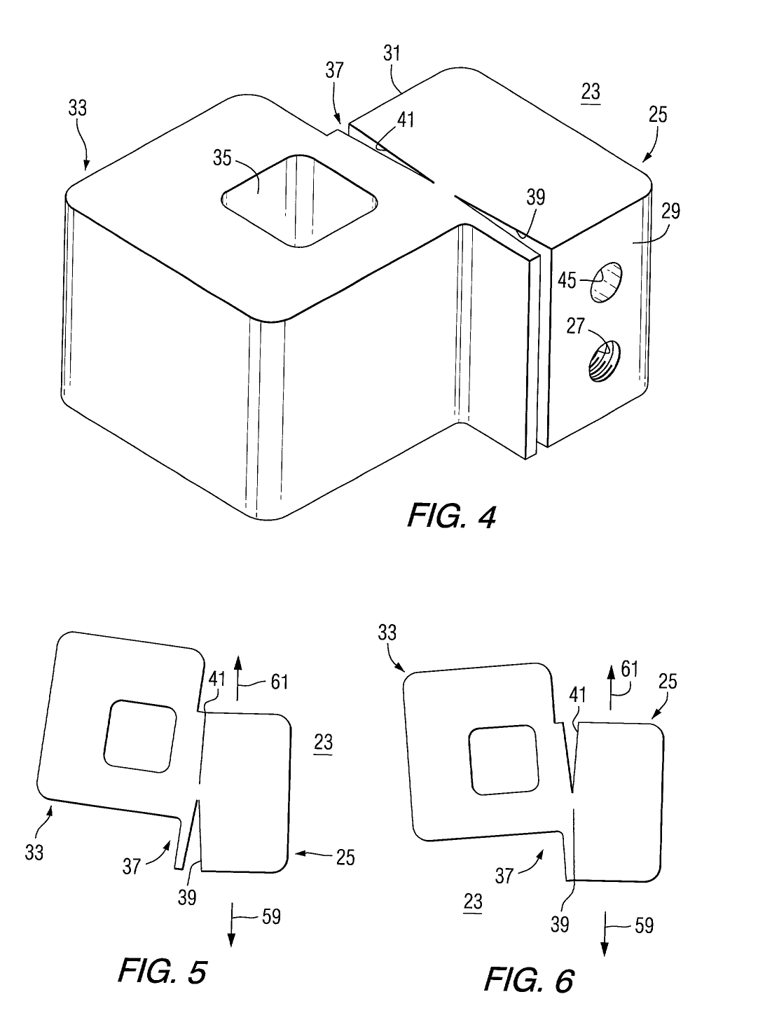

Turning to FIGS. 3 and 4, the motor operator 13, shown with the lid removed, includes a threaded rod 19 mounted for rotation about an axis generally parallel to the rectilinear path of the handle 3. The threaded shaft 19 is rotated by a drive motor 21. The motor operator 13 further includes a molded flexible coupling 23. This drive coupling 23 can be molded from delrin, nylon or other suitable resin. The coupling has a drive section 25 with a threaded through bore 27 extending between a first end 29 and a second end 31. The molded drive coupling 23 also includes a yoke section 33 positioned laterally of the through bore 27 in the drive section 25 and having a hole 35 generally transverse to the through bore 27 sized and shaped to engage the handle 3 of the circuit breaker. As shown, the hole 35 can extend all the way through the yoke section 33 so that the handle 3 can be extended to project through the motor operator lid 17 for manual operation.

The drive coupling also includes an integral intermediate section 37 joining the yoke section 33 and the drive section 25. This intermediate section 23 is formed by first and second slits 39 and 41 extending generally parallel to the through bore 27 from the first and second ends 29 and 31, respectively, of the coupling 23. In the exemplary embodiment, these slits 39 and 41 are longitudinally aligned and are V-shaped.

A guide is provided to prevent the coupling 23 from rotating with the threaded shaft. In the exemplary embodiment of the invention, the guide is a guide shaft 43 mounted parallel to the threaded shaft 19 and extending through a guide aperture 45 extending through the drive section 25 and parallel to the threaded bore 27. This guide shaft 43 prevents rotation of the coupling 23, so that as the motor 21 is operated, the coupling 23 moves rectilinearly along the threaded shaft 19.

Operation of the motor 21 is controlled by a pair of limit switches 47 and 49 mounted on a pair of adjustable brackets 51 and 53, respectively. The limit switch 47 has an actuating lever 55 which is depressed by the coupling 23 as the handle reaches the OFF position (which is downward in FIG. 3). Similarly, an actuating lever 57 is depressed by the coupling 23 as the handle reaches the ON position. A suitable circuit for operating the motor and including the limit switches 47 and 49 is disclosed in U.S. Pat. No. 5,695,046, which is hereby incorporated by reference.

Some of the molded case circuit breakers 1 require considerable force to move the handle, for example, in some molded case circuit breakers this can be 40-50 pounds. The motor 21 then must be able to develop sufficient starting torque to apply the commensurate force to the handle. In accordance with the invention, the flexibility of the coupling 23 allows the motor 21 to accelerate before it picks up the load of the handle. Referring to FIG. 5, it can be seen that as the drive section 25 of the coupling 23 is driven in the direction of the arrow 59, the yoke section 33 is restrained by the handle causing the intermediate section to flex until the slit 41 is closed. As this occurs, the motor develops sufficient torque that the handle is moved. When the toggle mechanism of the circuit breaker toggles, the handle 3 is accelerated and momentarily moves faster than the coupling 23, which is being driven by the motor. At this point, the yoke section 33 is carried forward by the handle 3 thereby flexing the intermediate section 37 and closing the slit 39 as shown in FIG. 6 until the handle recovers and is again moved along at the speed of the drive section 23.

As was mentioned, there has been a problem in the past with the motor operator hitting the end of travel causing it to rebound sufficiently that the off-limit switches become unactuated thereby turning the motor back on which results in pumping of the motor operator. With the flexible coupling 23 of the invention, when the handle reaches the end of its travel and stops, the yoke section 33 stops with it, but the drive section 25 continues on resulting in flexing of the intermediate section 37 and closing of the slit 39. When the drive section 25 stops, there is a tendency for it to rebound, but the slit 41 then closes to absorb the energy and prevent the limit switch 47 from becoming unactuated.

The reverse of the above sequence happens when the motor 21 drives the handle 3 in the opposite direction, that is from the OFF position to the ON position. With the motor 21 driving the drive section 25 in the direction of the arrow 61 in FIG. 6, the slit 39 is closed by initial movement of the drive section 25 allowing the motor to gain sufficient momentum before the handle is moved. When the toggle mechanism 11 toggles and the handle speeds ahead of the drive section 25, the slit 41 is closed as shown in FIG. 5. Also, the flexible coupling absorbs energy as the motor operator hits the upper end of travel in a similar manner as described above.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A motor operator for an electric power switch having a handle reciprocally moveable along a rectilinear path, the motor operator comprising:
a threaded shaft mounted adjacent and substantially parallel to the rectilinear path of the handle;
a motor rotating the threaded shaft;
a flexible molded drive coupling having a drive section with a threaded through bore extending from a first end to a second end of the drive coupling and engaging the threaded shaft, a yoke section lateral of the drive section and having a hole extending generally transverse to the through bore for engaging the handle, and an integral intermediate section joining the drive section and the yoke section formed by first and second slits extending generally parallel to the through bore from the first and second ends of the drive coupling; and
a guide preventing rotation of the drive coupling with rotation of the threaded shaft so that the drive coupling travels along the threaded shaft and moves the handle along the rectilinear path as the motor rotates the threaded shaft, the intermediate section being flexible and bending to selectively close the first and second slits in response to differences in travel speeds of the drive section and the yoke section.

2. The motor operator of claim 1 wherein the slits are longitudinally aligned.

3. The motor operator of claim 2 wherein the slits are v-shaped.

4. The motor operator of claim 1 wherein the slits are v-shaped.

5. The motor operator of claim 1 wherein the hole in the yoke section of the drive coupling is a through hole through which the handle of the electric power switch extends.

6. The motor operator of claim 1 wherein the guide comprises a guide rod mounted parallel to the threaded shaft, and the drive section of the molded coupling has a through aperture through which the guide rod extends.

7. An electrically operated electric power switch comprising:
a switch housing;
separable contacts mounted in the switch housing;
a toggle mechanism toggling the separable contacts between closed and open positions and having a handle projecting out of the switch housing and reciprocal along a rectilinear path to toggle the separable contacts between the closed and open positions; and
a motor operator comprising:
a threaded shaft mounted adjacent and substantially parallel to the rectilinear path of the handle;
a motor rotating the threaded shaft; and
a flexible molded drive coupling having a drive section with a threaded through bore extending from a first end to a second end of the drive coupling and engaging the threaded shaft, a yoke section lateral of the drive section and having a hole extending generally transverse to the through bore for engaging the handle, and an integral intermediate section joining the drive section and the yoke section formed by first and second slits extending generally parallel to the through bore from the first and second ends of the drive coupling.

8. The electric power switch of claim 7 wherein the slits are v-shaped.

9. The electric power switch of claim 8 wherein the slits are longitudinally aligned.

10. The electric power switch of claim 9 wherein the hole in the yoke section of the drive coupling is a through hole through which the handle extends.
